(19) United States
(12) Patent Application Publication
(10) Pub. No.: US 2012/0284095 A1
(43) Pub. Date: Nov. 8, 2012

(54) INTERNET-BASED METHOD OF CHARITABLE GIVING

(76) Inventor: Luca Antonio Andrea FRIGERIO, Milano (IT)

(21) Appl. No.: 13/102,368

(22) Filed: May 6, 2011

(51) Int. Cl. G06Q 30/00

(52) U.S. Cl. 705/14.7

(57) ABSTRACT

An Internet-based method of charitable giving includes the steps of:
creating a charitable fund by a fund manager (S1);
registering by a user (S2),
acquiring (S3) by the user at least one portion of the amount of money an advertiser pays the content provider for the on-line advertising, as a share of the charitable fund;
selecting (S4) by the user a charitable organization; and
destining (S5) by the user at least a portion of the acquired share of the charitable fund to the selected charitable organization.

### TECHNICAL FIELD OF THE INVENTION

The present invention relates to an Internet-based method of charitable giving. More specifically, the present invention relates to a method suitable for linking charitable giving with Internet-based advertising.

### BACKGROUND OF THE INVENTION

Throughout the world, there are people who are underprivileged and lack some of the basic necessities of life. For various reasons, these people do not have the financial means to provide for some of the life's basic requirements. Moreover, environment catastrophes, such as earthquakes and tsunamis, can occur, which causes a lot of people to remain without home.

A variety of programs exist to help these people, but they all fall short in one respect or another. Further, a number of charitable groups exist to help the poor, the church related groups being examples of such charities. In many instances, these groups do an excellent job of helping those in need. Sadly, these charities often suffer from a lack of funding, so they cannot help all those who need it.

Due to the paucity of funds currently given to charities, there is need for a method which will increase the funding for charities.

A typical method of collecting funds consists of charitable SMS messages or phone calls. Charitable SMS messages or phone calls allow people to directly donate small sums, e.g. one or two US dollars via a simple SMS message, and one, two or five US dollars via a simple phone call. All funds collected are handed over in their entirety to the participating associations.

Another known method of charitable giving consists of on-line purchasing fair trade products and/or services and of devoting a portion or all the proceeds to social and/or local organizations.

The above mentioned methods requires the user to physically or virtually transfer an amount of money from his/her phone credit or account to the account of the charitable organization.

It is also known a method of charitable investing/purchasing, which involves the use of a financial instrument or a financial account or service, e.g. mutual funds, life insurance policies, brokerage accounts, trust accounts and the like. More specifically, this known method consists of redirecting a portion of the fees normally deducted from the value of the investment instrument, account or service to a charitable organization and similar realities.

Alternatively, the method involves a purchasing account, such as a credit card or debit card account. The difference between what the consumer pays for purchases and what the credit/debit card company pays the merchant represents a fee paid to the card issuer. Part of the fee from this special structured credit/debit card is given to the charitable organization(s).

This latter method is very complex in that it involves many subjects, i.e. potential donors, investment advisors, financial instrument or account managers and charitable organizations.

Banners are the most common mode of advertisement in Internet. They consist of embedding an advertisement into a web page and are intended to attract traffic to a website by linking to the website of the advertiser.

The web banner is displayed when a web page that references the banner is loaded into a web browser. This event is known as an “impression”. When a net surfer gets interested in promotional message of a banner, he/she clicks on it to learn more and is automatically directed to the web site advertised in the banner. This event is known as a “click through”.

The advertiser pays the content provider a small amount of money, e.g. five or ten US cents, for each click on the banner (“pay per click”) and/or impression of the web page containing the banner (“pay per impression”).

### SUMMARY OF THE INVENTION

The main object of the present invention is to provide an Internet-based method of charitable giving which does not require the user to purchase any fair trade product and/or service.

More specifically, the method uses on the daily habit of a user to net surf and consists of collecting into a fund part or all the amount of money advisers pay the content provider for each click on their banner or impression of the web page containing the banners. The content of the fund is then destined to one or more charitable organizations.

Another object of the present invention is to provide an Internet-based method of charitable giving that will increase the amount of money donated to charitable organizations.

Still another object of the present invention is to provide an Internet-based method of charitable giving that will optimize the distribution of the amount of money collected in the fund among the charitable organizations by following substantially in real time the effective needs all around the world.

Another object of the present invention is to provide an Internet-based method of charitable giving that is easy to implement and efficiency in operation.

These and other objects, features, and advantages of the present invention, which will be apparent from the following detailed description thereof, are obtained by the inventive method of Internet-based charitable giving, whose features are listed in the enclosed independent claim 1.

Advantageous aspects of the invention appear from the dependent claims.

Therefore, the invention provides an Internet-based method of charitable giving comprising the steps of:
creating a charitable fund by a fund manager;
registering by a user,
acquiring by the user at least one portion of the amount of money an advertiser pays the content provider for the on-line advertising, as a share of the charitable fund;
selecting by the user a charitable organization; and
destining by the user at least a portion of the acquired share of the charitable fund to the selected charitable organization.

### DESCRIPTION OF THE DRAWINGS

Further characteristics of the invention will appear clearer from the following detailed description, referring to purely exemplary and therefore non limiting embodiments thereof, illustrated in the appended drawings, wherein:

FIG. 1 is a flowchart of a preferred Internet-based method of charitable giving according to the present invention;

FIG. 2 is a flowchart of a first example of implementing the charitable method according to the present invention;

FIG. 3 is a flowchart of a second example of implementing the charitable method according to the present invention; and

FIG. 4 is a flowchart of a third example of implementing the charitable method according to the present invention;

### DESCRIPTION OF PREFERRED EMBODIMENTS OF THE INVENTION

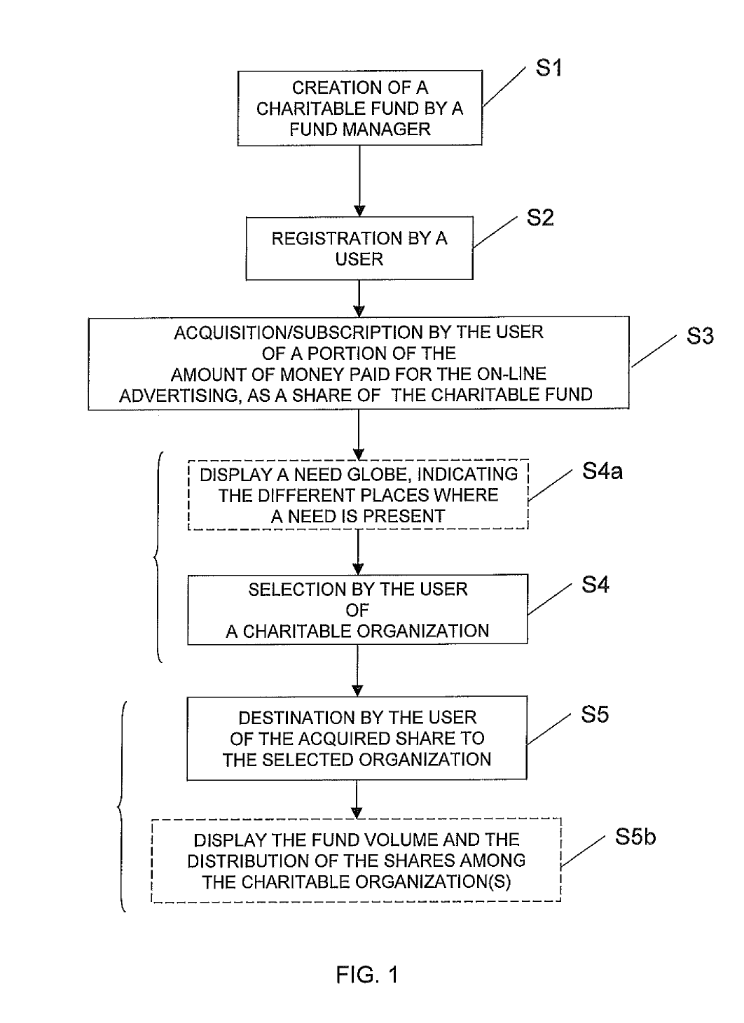

A preferred Internet-based charitable method is schematically shown in FIG. 1.

The first step of the method is the creation of a charitable fund by a fund manager, typically a banking company (step S1). Specifically, the charitable fund will contain a plurality of shares, each share consisting of a portion or the total amount of money paid for the on-line advertising.

The second step of the method is the registration by a user to the charitable fund, for example by assigning a user name and a password (step S2). In the following of this specification, the term user is employed to indicate a content provider, for example a website offering on-line advertising, and a net surfer.

The third step of the method is the acquisition of at least one share of the charitable fund by the user (step S3), according to the following modalities:
the share is directly acquired, through a subscription, by the content provider, which decides to destine a variable portion of the advertising revenues as shares of the charitable fund; and
the share is indirectly acquired by a net surfer each time he/she visit a web page containing payment advertising, as a variable percentage or the totality of the amount of money an advertiser pays the content provider for each impression, according to the pay per impression modality; and
the share is indirectly acquired by a net surfer each time he/she clicks on an advertising banner, as a variable percentage or the totality of the amount of money an advertiser pays the content provider for each click on the banner, according to the pay per click modality.

The fourth step of the method is the selection of the charitable organization(s) or project(s) to which destine the acquired share of the charitable fund. Specifically, the acquired share can be destined partially, totally or thought the realized appreciation (Step S4).

In order to facilitate the selection of the desired charitable organization by the user, the method provides a step S4a of displaying a globe, in the following “need globe”, in which the different places where a need is present, for example the place where an earthquake or a tsunami has occurred, are indicated. The need globe can be, for example, an Internet interactive map, which can be updated in real time by the charitable organizations and consulted in real time by the user.

Therefore, if a natural disaster occurs in any part of the earth, a charitable organization can update in real time the need globe by including therein the newly occurred need. As a consequence, a user registered to the charitable fund is quickly informed that a new need exists and can thus choose to destine to it the acquired share of the charitable fund.

The fifth step of the method is destining the acquired/subscribed share of the charitable fund to the selected charitable organization(s) and/or charitable project(s) (step S5).

Preferably, the method provides, upstream to the step S5, a further step S5b of displaying in real time to the user and the subscriber of the share of the charitable fund the volume of the fund and the distribution of the shares among the charitable organization(s) and/or project(s). For example, there could be provided a toolbar having an indicator which updates in real time on the acquired share and on the selected share destination.

Preferably, the subscribed/acquired shares of the charitable fund can be redeemed. However, in this case, it is compulsory that a portion of the share not lower than the 50% to be destined to a charitable project.

Preferably, a minimum time period can be determined, within which the percentage of the share cannot be redeemed. In the event the user does not select the charitable organization(s) to which destine the acquired share or he/she does not redeem the percentage of the acquired share, this latter is automatically entirely destined to the charitable organization which is more in need of funds, selected by means of a suitable algorithm.

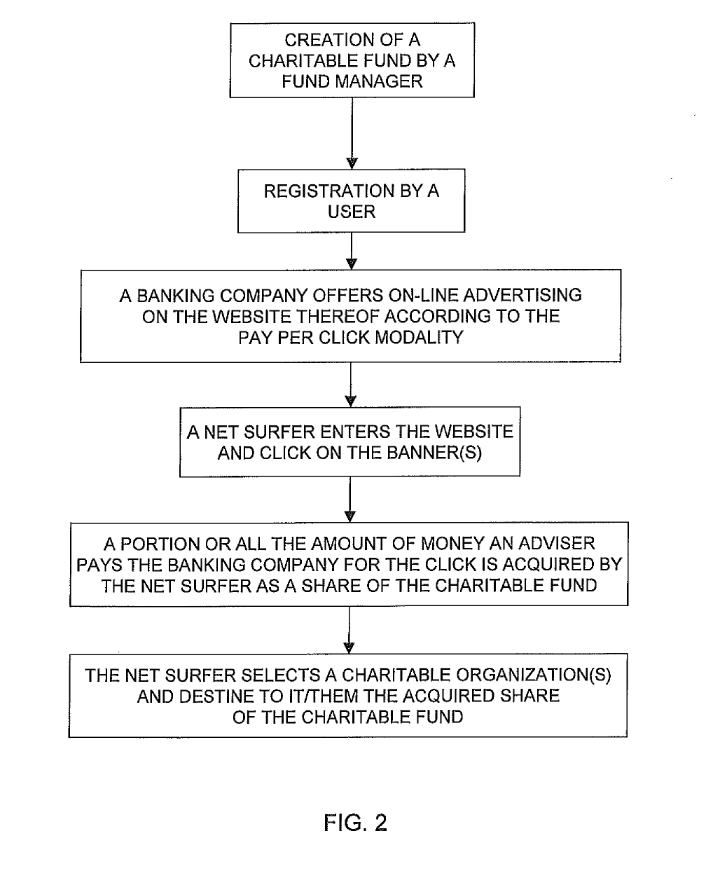

With reference to FIG. 2, it is illustrated a flowchart of a first example of implementing the charitable method of the invention.

In particular, it is assumed that a banking company offers payment advertising on the website thereof, according to the pay per click modality, thus acting as the content provider. Therefore, the website contains a plurality of banners, each linking to the website advertised in the banner.

When a net surfer, previously registered to the charitable fund, enters the website of the banking company and clicks on the banner(s) visible therein, he/she partially or totally acquires the small amount of money the adviser pays the banking company for the click, as a share of the charitable fund previously created.

To inform the net surfer that, by clicking on the banner, he/she can acquire a share of the charitable fund, a message or a logo is preferably displayed on the web page adhering to the project.

After a period of time, such acquired share is partially or totally destined to a charitable organization(s) or project(s) directly selected by the net surfer on the need globe.

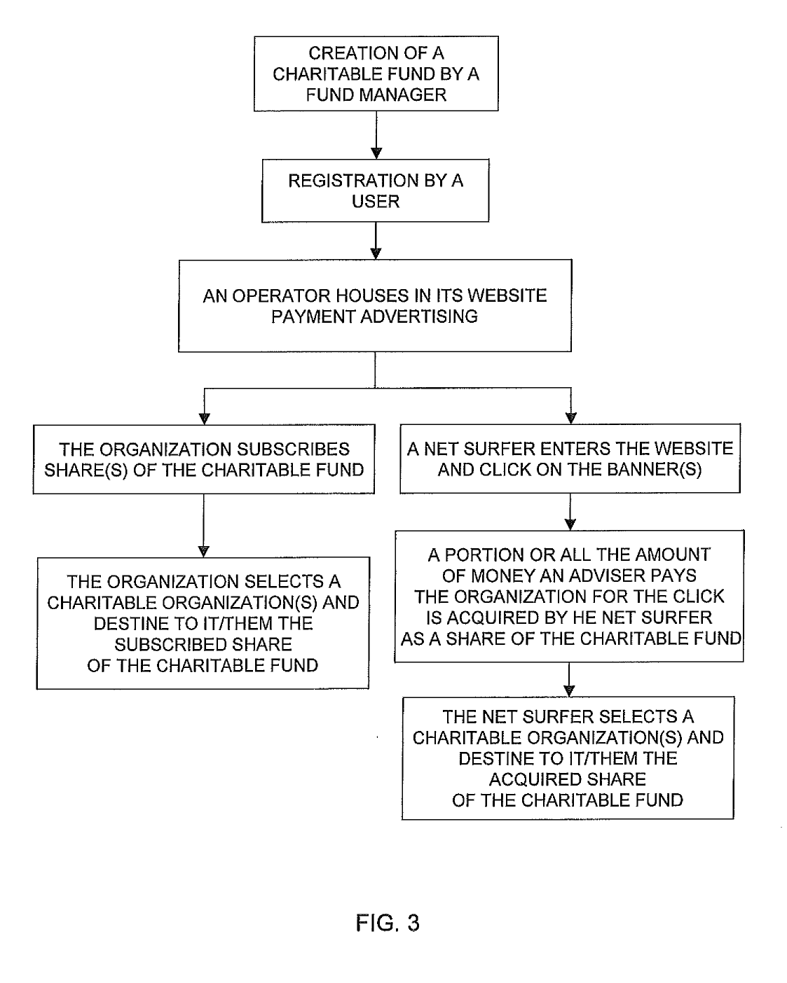

With reference to FIG. 3, it is illustrated a flowchart of a second example of implementing the charitable method of the invention.

It is assumed that the content provider is an organization different from the banking company, for example a national newspaper or an operator in the food and clothing business, which houses in its website payment advertising.

As described above, the organization can directly operate, by subscribing shares of the charitable fund and destining a variable percentage of the subscribed share to selected charitable organization(s) and/or project(s) by using the need globe.

Alternatively, the operator can choose to destine a portion of the advertising revenue as a share, which is indirectly acquired by the net surfer by visiting the operator website or clicking on a banner. In turn, the net surfer can destine a variable percentage of the acquired share to selected charitable organization(s) and/or project(s) by using the need globe.

Further alternatively, the operator can choose to destine a variable percentage of the advertising revenue, for example the 50%, to the subscription of a share of the charitable fund, and the remaining portion thereof, i.e. the other 50%, to the net user visiting the website as a share acquired, for example, by clicking on the banner. The operator and the net surfer can then independently destine a variable percentage of the subscribed/acquired share to respective selected charitable organization(s) and/or project(s) by using the need globe.

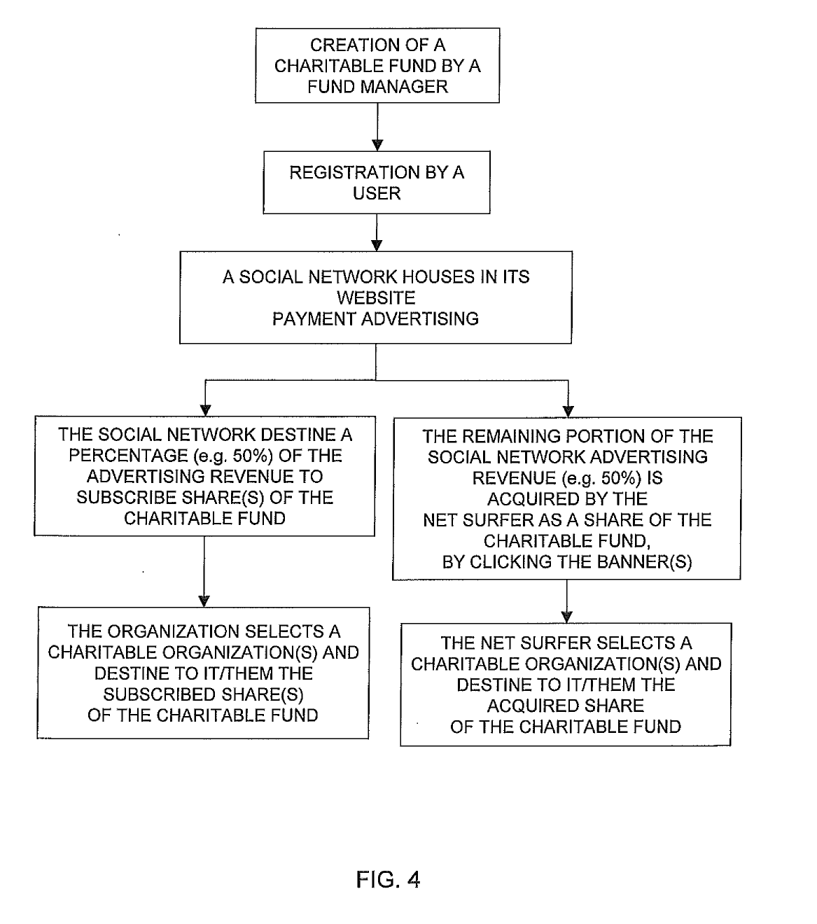

With reference to FIG. 4, it is illustrated a flowchart of a third example of implementing the charitable method of the invention.

It is assumed that the content provider is a social network, which houses in its website payment advertising.

Also in this case, the social network can directly operate, by subscribing shares of the charitable fund and destining a variable percentage of the subscribed share to selected charitable organization(s) and/or project(s) by using the need globe.

Alternatively, the social network can choose to destine a portion of the advertising revenue as a share, which is indirectly acquired by the members of the social network, for example by clicking on a banner. In turn, the net surfer can destine a variable percentage of the subscribed share to selected charitable organization(s) and/or project(s) by using the need globe.

Further alternatively, the social network can choose to destine a variable percentage of the advertising revenue, for example the 50%, to the subscription of a share of the charitable fund, and the remaining portion thereof, i.e. the other 50%, to the member visiting the website as a share acquired, for example, by clicking on the banner. The social network and the members thereof can, then, independently destine a variable percentage of the subscribed/acquired share to respective selected charitable organization(s) and/or project(s) by using the need globe.

Therefore, the Internet-based charitable method of the invention allows a registered user, typically a net surfer, to make donations without spend any money. Specifically, the websites housing payment advertising can see the advisers and the click number to increase, whereas the net surfer can make donations by simply visiting the websites or clicking the banners. Finally, the destination of the shares of the charitable fund is freely chosen by the user on the need globe.

Moreover, the gain of fund manager derives from the management of the money, specifically the 50% of the fund. Finally, if the user decide to destine to a desired charitable organization only a portion of the acquired share of the charitable fund, he/she can invest the remaining portion thereof, as needed, e.g. by appropriating it on a investment, deposit account, end the like.

In the drawings and specification there has been set forth preferred and alternative methods according to the invention and, although specific terms are employed, these are used in a generic and descriptive sense only and not for purpose of limitation. Changes in one or more steps are contemplated without departing from the spirit or scope of the invention as further defined in the following claims.

1. An Internet-based method of charitable giving comprising the steps of:
creating a charitable fund by a fund manager (S1);
registering by a user (S2),
acquiring (S3) by the user at least one portion of the amount of money an advertiser pays the content provider for the on-line advertising, as a share of the charitable fund;
selecting (S4) by the user a charitable organization; and
destining (S5) by the user at least a portion of the acquired share of the charitable fund to the selected charitable organization.

2. A method according to claim 1, wherein the share is directly acquired, through a subscription, by the content provider, which decide to destine a variable portion of the advertising revenue as shares of the charitable fund.

3. A method according to claim 1, wherein the share is indirectly acquired by a user-net surfer each time he/she visit a web page containing payment advertising, as at least a portion of the amount of money an advertiser pays the content provider for each impression, according to the pay per impression modality.

4. A method according to claim 1, wherein the share is indirectly acquired by a user-net surfer each time he/she clicks on an advertising banner, as at least a portion of the amount of money an adviser pays the content provider for each link on the banner, according to the pay per click modality.

5. A method according to claim 1, wherein it comprises, upstream to the step (S4) of selecting (S4) by the user a charitable organization, a further step (S4a) of displaying a need globe, in which the different places where a need are indicated, said need globe being suitable for being updated in real time by the charitable organizations and being suitable for being consulted in real time by the user.

6. A method according to claim 1, wherein it comprises, downstream to the step (S5) of destining (S5) by the user at least a portion of the acquired share of the charitable fund to the selected charitable organization, a further step (S5b) of displaying in real time to the user the volume of the charitable fund and the distribution of the shares among the selected charitable organizations.

7. A method according to claim 1, wherein a portion of the shares of the charitable fund not greater that the 50% can be redeemed by the user.

8. A method according to claim 7, wherein a minimum time period can be determined within which the percentage of the share cannot be redeemed, and in the event the user does not select the charitable organization(s) to which destine the acquired share or he/she does not redeem the percentage of the acquired share, this latter is automatically entirely destined to the charitable organization which is more in need of funds.
